(19) United States
(12) Patent Application Publication
(10) Pub. No.: US 2002/0091196 A1
(43) Pub. Date: Jul. 11, 2002

(54) Polyester resin composition

(75) Inventors: Toshiki Mori, Osaka (JP); Toru Fujiki, Osaka (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: SUMITOMO CHEMICAL COMPANY, LIMITED

(21) Appl. No.: 09/982,789

(22) Filed: Oct. 22, 2001

(30) Foreign Application Priority Data
Nov. 10, 2000 (JP) 2000-343303

(51) Int. Cl. C08F 8/00

(52) U.S. Cl. 525/107

(57) ABSTRACT

There is provided a polyester resin composition, which comprises:

(A) 100 parts by weight of a polyester resin,

(B) 1 to 50 parts by weight of at least one copolymer selected from the group consisting of an ethylene-α-olefin copolymer and an ethylene-α-olefin-polyene compound copolymer, and

(C) 1 to 16 parts by weight of an epoxy group-containing ethylene copolymer,

provided that an S value represented by the following formula (1) is from 2.5 to 4.5,

S=log [B]+log [C] (1)

wherein [B] and [C] are parts by weight of the component [B] and the component [C] based on 100 parts by weight of the component [A], respectively.

### FIELD OF THE INVENTION

The present invention relates to a polyester resin composition having superior impact resistance and superior flowability More specifically, the present invention relates to a polyester resin composition, which can exhibit superior impact resistance and superior flowability, even when a polyester resin used for production of the present resin composition contains a recycled polyester resin.

### BACKGROUND OF THE INVENTION

It is desired to recover and recycle a container made of a polyester resin such as polyethylene terephthalate, which container is hereinafter referred to as “PET bottle”. However, the recycled polyester resin has a problem that its impact resistance is inferior.

As a resin composition capable of solving such a problem, JP 63-4566B discloses a resin composition comprising a polyester resin, an ethylene-α-olefin copolymer and an epoxy group-containing ethylene copolymer.

However, the resin composition disclosed in JP 63-4566B has a problem that its flowability is so low that its moldability is inferior.

### SUMMARY OF THE INVENTION

It is an object of the present invention to provide a polyester resin composition having superior impact resistance and superior flowability.

It is another object of the present invention to provide a polyester resin composition, which can exhibit superior impact resistance and superior flowability, even when a polyester resin used for production of the present resin composition contains a recycled polyester resin.

The present inventors have undertaken extensive studies to find a polyester resin composition, according to which above-mentioned objects can be accomplished. As a result, it has been found that such a polyester resin composition can be obtained by using resin components in their specific proportions. Thereby, the present invention has been obtained.

That is, the present invention provides a polyester resin composition, which comprises:

(A) 100 parts by weight of a polyester resin,

(B) 1 to 50 parts by weight of at least one copolymer selected from the group consisting of an ethylene-α-olefin copolymer and an ethylene-α-olefin-polyene compound copolymer, and

(C) 1 to 16 parts by weight of an epoxy group-containing ethylene copolymer,

provided that an S value represented by the following formula (1) is from 2.5 to 4.5,

S=log [B]+log [C] (1)

wherein [B] and [C] are parts by weight of the component [B] and the component [C] based on 100 parts by weight of the component [A], respectively.

### DETAILED DESCRIPTION OF THE INVENTION

Examples of the poltyester resin used as the component (A) in the present invention are condensation polymerization products between a diol and a dicarboxylic acid. The “dicarboxylic acid” means not only free dicarboxylic acids but also derivatives thereof such as esters, acid anhydrides and halides of said dicarboxylic acids.

Examples of the diol are linear or branched chain aliphatic diols having about from 2 to 20 carbon atoms such as ethylene glycol, 1,3-propanediol, 1,4-butanediol, 1,5-pentanediol, 1,6-hexanediol, 1,10-decanediol and neopentyl glycol; alicyclic group-containing dials such as 1,4-cyclohexanediol and 1,4-cycloheanediethanol; and long chain glycols having a molecular weight of about from 400 to 6000 such as polyethylene glycol, poly-1,3-propylene glycol and polytetramethylene glycol. In using, two or more diols mentioned above may be combined.

Examples of the dicarboxylic acid are aliphatic dicarboxylic acids having approximately from 2 to 20 carbon atoms such as azelaic acid, adipic acid, sebacic acid and dodecanedicarboxylic acid; aromatic dicarboxylic acids such as terephthalic acid, isophthalic acid, phthalic acid, bis(4-carboxyphenyl)methane, 1,2-bis(4-carboxyphenyl)ethane, 4,4′-dicarboxybiphenyl ether and naphthalenedicarboxylic acid; alicyclic group-containing dicarboxylic acids such as cyclohexanedicarboxylic acid; and methyl esters, ethyl esters, acid anhydrides and halides of those dicarboxylic acids. In using, two or more dicarboxylic acids mentioned above may be combined, Particularly, a dicarboxylic acid containing not less than about 40% by mole of terephthalic acid is preferred.

Examples of the polyester resin are polyethylene terephthalate resin, polypropylene terephthalate resin, polybutylene terephthalate resin, polyhexamethylene terephthalate resin, polyethylene naphthalate resin, polybutylene naphthalate resin, polycyclohexanediethylene terephthalate resin and polyneopentyl terephthalate. A mixture comprising two or more polyester resins mentioned above may be used.

Examples of preferred polyester resins are polyethylene terephthalate; condensation polymerization products of a mixture containing isophthalic acid and terephthalic acid with ethylene glycol; condensation polymerization products of a mixture containing adipic acid and terephthalic acid with ethylene glycol; condensation polymerization products of a mixture containing decanedicarboxylic acid and terephthalic acid with ethylene glycol; condensation polymerization products of a mixture containing ethylene glycol and propylene glycol with terephthalic acid; and condensation polymerization products of a mixture containing ethylene glycol and butylene glycol with terephthalic acid. A particularly preferred polyester resin is that obtained from a dicarboxylic acid containing not less than about 80% by mole of terephthalic acid and a diol containing not less than about 80% by mole of ethylene glycol.

As the polyester resin used in the present invention, preferred is a polyester resin comprising a recycled polyester resin. The “recycled polyester resin” means a polyester resin obtained by making a used molded polyester resin article such as a PET bottle into the form of powder, chop or pellet for the purpose of reuse.

An intrinsic viscosity of the polyester resin measured at 25° C. using o-chlorophenol as a solvent is usually approximately from 0.5 to 1.0 dl/g. A terminal carboxyl group concentration in the polyester resin is usually approximately from 15 to 200 milli-equivalent/Kg.

Examples of the α-olefin in the ethylene-α-olefin copolymers and the ethylene-α-olefin-polyene compound copolymers used as the component (B) in the present invention are linear chain α-olefins such as propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nanodecene and 1-eicocene; and branched α-olefins such as 3-methyl-1-butene, 3-methyl-1-pentene, 4-methyl-1-pentene, 2-ethyl-1-hexene and 2,2,4-trimethyl-1-pentene. Among these, preferred are linear chain α-olefins. Particularly preferred are propylene, 1-butene, 1-pentene, 1-hexene, 1-octene and 1-decene.

Examples of the polyene compound in the component (B) used in the present invention are those having more than one double bond such as, for example, conjugated polyene compounds and non-conjugated polyene compounds.

Examples of the conjugated polyene compounds are linear chain aliphatic conjugated polyene compounds, branched aliphatic conjugated polyene compounds and alicyclic conjugated polyene compounds. The conjugated polyene compounds may have a substituent such as an alkoxy group, an aryl group, an aryloxy group, an aralkyl group or an aralkyloxy group.

Examples of the aliphatic conjugated polyene compounds

| | |
|---|---|
| are 1,3-butadiene, isoprene, | 2-ethyl-1,3-butadiene, |
| 2-propyl-1,3-butadiene, | 2-isopropyl-1,3-butadiene, |
| 2-hexyl-1,3-butadiene, | 2,3-dimethyl-1,3-butadiene, |
| 2,3-diethyl-1,3-butadiene, | 2-methyl-1,3-pentadiene, |
| 2-methyl-1,3-hexadiene, | 2-methyl-1,3-octadiene, |
| 2-methyl-1,3-decadiene, | 2,3-dimethyl-1,3-pentadiene, |
| 2,3-dimethyl-1,3-hexadiene, | 2,3-dimethyl-1,3-octadiene and |
| 2,3-dimethyl-1,3-decadiene. | |

Examples of the alicyclic conjugated polyene compounds

| | |
|---|---|
| are 2-methyl-1,3-cyclopentadiene, | 2-methyl-1,3-cyclohexadiene, |
| 2,3-dimethyl-1,3-cyclopentadiene, | 2,3-dimethyl-1,3-cyclohexadiene, |
| 2-chloro-1,3-cyclobutadiene, | 2,3-dichloro-1,3-cyclobutadiene, |
| 1-fluoro-1,3-cyclobutadiene, | 2-chloro-1,3-cyclopentadiene, |
| 2-chloro-1,3-cyclopentadiene and | 2-chloro-1,3-cyclohexadiene. |

Examples of the non-conjugated polyene compounds are linear chain aliphatic non-conjugated polyene compounds, branched aliphatic non-conjugated polyene compounds, alicyclic non-conjugated polyene compounds and aromatic non-conjugated polyene compounds. The non-conjugated polyene compounds may have a substituent such as an alkoxy group, an aryl group, an aryloxy group, an aralkyl group or an aralkyloxy group.

Examples of the aliphatic non-conjugated polyene compounds are 1,4-hexadiene, 1,5-hexadiene, 1,6-heptadiene, 1,6-octadiene, 1,7-octadiene, 1,8-nonadiene, 1,9-decadiene,

| | |
|---|---|
| 1,13-tetradecadiene, | 1,5,9-decatriene, |
| 3-methyl-1,4-hexadiene, | 4-methyl-1,4-hexadiene, |
| 5-methyl-1,4-hexadiene, | 4-ethyl-1,4-hexadiene, |
| 3-methyl-1,5-hexadiene, | 3,3-dimethyl-1,4-hexadiene, |
| 3,4-dimethyl-1,5-hexadiene, | 5-methyl-1,4-heptadiene, |
| 5-ethyl-1,4 heptadiene, | 5-methyl-1,5-hepatdiene, |
| 6-methyl-1,5-heptadiene, | 5-ethyl-1,5-heptadiene, |
| 3-methyl-1,6-heptadiene, | 4-methyl-1,6-heptadiene, |
| 4,4-dimethyl-1,6-heptadiene, | 4-ethyl-1,6-heptadiene, |
| 4-methyl-1,4-octadiene, | 5-methyl-1,4-octadiene, |
| 4-ethyl-1,4-octadiene, | 5-ethyl-1,4-octadiene, |
| 5-methyl-1,5-octadiene, | 6-methyl-1,5-octadiene, |
| 5-ethyl-1,5-octadiene, | 6-ethyl-1,5-octadiene, |
| 6-methyl-1,6-octadiene, | 7-methyl-1,6-octadiene, |
| 6-ethyl-1,6-octadiene, | 6-propyl-1,6-octadiene, |
| 6-butyl-1,6-octadiene, | 4-methyl-1,4-nonadiene, |
| 5-methyl-1,4-nonadiene, | 4-ethyl-1,4-nonadiene, |
| 5-ethyl-1,4-nonadiene, | 5-methyl-1,5-nonadiene, |
| 6-methyl-1,5-nonadiene, | 5-ethyl-1,5-nonadiene, |
| 6-ethyl,1,5-nonadiene, | 6-methyl-1,6-nonadiene, |
| 7-methyl-1,6-nonadiene, | 6-ethyl-1,6-nonadiene, |
| 7-ethyl-1,6-nonadiene, | 7-methyl-1,7-nonadiene, |
| 8-methyl-1,7-nonadiene, | 7-ethyl-1,7-nonadiene, |
| 5-methyl-1,4-decadiene, | 5-ethyl-1,4-decadiene, |
| 5-methyl-1,5-decadiene, | 6-methyl-1,5-decadiene, |
| 5-ethyl-1,5-decadiene, | 6-ethyl-1,5-decadiene, |
| 6-methyl-1,6-decadiene, | 6-ethyl-1,6-decadiene, |
| 7-methyl-1,6-decadiene, | 7-ethyl-1,6-decadiene, |
| 7-methyl-1,7-decadiene, | 8-methyl-1,7-decadiene, |
| 7-ethyl-1,7-decadiene, | 8-ethyl-1,7-decadiene, |
| 8-methyl-1,8-decadiene | 9-methyl-1,8-decadiene, |
| 8-ethyl-1,8-decadiene, | 6-methyl-1,6-undecadiene, |
| 9-methyl-1,8-undecadiene, | 6,10-dimethyl-1,5,9-undecatriene, |

5,9-dimethyl-1,4,8-decatriene,
4-ethylidene-8-methyl-7-nonadiene,
13-ethyl-9-methyl-1,9,12-pentadecatriene,
5,9,13-trimethyl-1,4,8,12-tetradecadiene,
8,14,16-trimethyl-1,7,14-hexadecatriene and
4-ethylidene-12-methyl-1,11-pentadecadiene.
Examples of the alicyclic non-conjugated polyene

| | |
|---|---|
| compounds are vinylcyclohexene, | 5-vinyl-2-norbornene, |
| 5-ethylidene-2-norbornene, | 5-methylene-2-norbornene, |
| 5-isopropenyl-2-norbornene, | cyclohexadiene, |
| dicyclopentadiene, cyclooctadiene, | 2,5-norbornadiene, |
| 2-methyl-2,5-norbornadiene, | 2-ethyl-2,5-norbornadiene, |
| 2,3-diisopropylidene-5-norbornene, | |

2-ethylidene-3-isopropylidene-5-norbornene,
6-chloromethyl-5-isopropenyl-2-norbornene,

| | |
|---|---|
| 1,4-divinylcyclohexane, | 1,3-divinylcyclohexane, |
| 1,3-divinylcyclopentane, | 1,5-divinylcyclooctane, |
| 1-allyl-4-vinylcyclohexane, | 1,4-diallylcyclohexane, |
| 1-allyl-5-vinylcyclooctane, | 1,5-diallylcyclooctane, |
| 1-allyl-4-isopropenylcyclohexane, | 1-isopropenyl-4-vinylcyclohexane, |

1-isopropenyl-3-vinylcyclopentane and
mothyltotrahydroindene.

Providing the sum of units in the copolymer of the component (B) is assigned to be 100% by mole, a content of the ethylene unit in the copolymer is usually approximately from 10 to 99% by mole, that of the α-olefin unit is usually approximately from 1 to 90% by mole, and that of the polyene compound unit is usually approximately from 0 to 50% by mole. Here, the “unit” means a structural unit in the polymer derived from respective monomers. For example, an “ethylene unit” means a structural unit derived from ethylene.

The copolymer of the component (B) can be obtained, for example, in a conventional manner, according to which monomers are subjected to polymerization in the presence of a polymerization catalyst such as a Ziegler Natta catalyst and a metallocene catalyst. The metallocene catalyst contains, for example, a complex of a transition metal belonging to the 4A to 6A groups In the periodic table, which complex has at least one cyclopentadienyl skeleton, Specific examples thereof are disclosed in, for example, JP 9-12635A and JP 9-151205A.

The copolymer of the component (B) may be used in combination with a different thermoplastic resin such as polypropylene and polyethylene in a manner such that the objects of the present Invention are not impaired Particularly, In the case where it is difficult to dry-blend the copolymer with the component (A) or the component (C) because of inter-adhesion property of the copolymer, it is recommended to use a component, which is obtained by melt-kneading the copolymer with such a different thermoplastic resin, followed by pelletization.

The epoxy group-containing ethylene copolymer used as the component (C) in the present invention is a copolymer comprising an ethylene unit and an epoxy group-containing compound unit. The copolymer may additionally comprise an ethylenically unsaturated ester compound unit. Providing the sum of units in the copolymer is assigned to be 100% by weight, a content of the ethylene unit in the copolymer is usually approximately from 20 to 99% by weight, that of the epoxy group-containing compound unit is usually approximately from 1 to 30% by weight, and that of the ethylenically unsaturated ester compound unit is usually approximately from 0 to 50% by weight.

One embodiment of the epoxy group-containing compound is that represented by the following formula (2), wherein R is an alkenyl group having 2 to 18 carbon atoms, and X is a carbonyloxy group, a methyleneoxy group or a phenyleneoxy group.

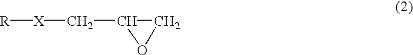

Among those represented by the above formula (2), preferred are an unsaturated carboxylic acid glycidyl ester, which has a carbonyloxy group as X, and an unsaturated carboxylic acid glycidyl ether, which has a methyleneoxy group as X.

Examples of the unsaturated carboxylic acid glycidyl ester are glycidyl acrylate, glycidyl methacrylate and glycidyl itaconate. Examples of the unsaturated carboxylic acid glycidyl ether are allyl glycidyl ether, methallyl glycidyl ether and styrene-p-glycidyl ether.

The above-mentioned ethylenically unsaturated ester compound is a compound having no glycidyl ester group. Specific examples thereof are saturated carboxylic acid vinyl esters such as vinyl acetate, vinyl propionate and vinyl butylate; and unsaturated carboxylic acid alkyl esters such as methyl acrylate, ethyl acrylate, butyl acrylate, methyl methacrylate, ethyl methacrylate and butyl methacrylate. Of these, preferred are vinyl acetate, methyl acrylate, ethyl acrylate and methyl methacrylate.

The epoxy group-containing ethylene copolymer may be any of block copolymers, graft copolymers, random copolymers or alternative copolymers. Said copolymer may be a copolymer obtained by grafting an epoxy group-containing compound upon a propylene-ethylene block copolymer (Japanese Patent 6232980), and a copolymer obtained by grafting an ethylenically unsaturated ester compound upon a copolymer having ethylene units and epoxy group-containing monomer units (Japanese Patent 2600248).

An MFR (melt flow rate) of the epoxy group-containing ethylene copolymer, which MFR is measured according to JIS K7210 under conditions of 190° C. and 2.16 kg, is preferably approximately from 0.5 to 100 g/10 min., and more preferably approximately from 2 to 50 g/10 min., from a viewpoint of molding processability and mechanical properties such as Izod impact strength of the polyester resin composition obtained.

A number average molecular weight of the epoxy group-containing ethylene copolymer measured by gel permeation chromatography and expressed in terms of that of polystyrene is preferably approximately from 10,000 to 100,000, from a viewpoint of mechanical properties such as Izod impact strength and molding processability of the polyester resin composition obtained.

The epoxy group-containing ethylene copolymer can be obtained, for example, (i) by copolymerizing monomers using a radical generator in the presence or absence of a suitable solvent and a chain transfer agent under a pressure of approximately from 500 to 4000 atm. at a temperature of approximately from 100 to 300° C., or (ii) by mixing polyethylene, the epoxy group-containing compound monomer, a radical generator and, if necessary, the ethylenically unsaturated ester with one another, and then melt-graft-copolymerizing the obtained mixture in an extruder.

The S value represented by the above formula (1) is from 40 to 145, and preferably from 45 to 135. When the S exceeds 145, the polyester resin composition obtained tends to lower its flowability. When the S Is less than 40, the polyester resin composition obtained tends to lower its impact resistance, so that an article molded from said composition tends to crack.

The sum of the components (B) and (C) is preferably approximately from 10 to 30 parts by weight based on 100 parts by weight of the component (A) from a viewpoint of impact resistance and flowability of the polyester resin composition to be obtained. When the component (B) is not less than 5 parts by weight, the component (C) is preferably not more than about 10 parts by weight based on 100 parts by weight of the component (A), from a viewpoint of flowability of the polyester resin composition obtained.

A preferable MFR (melt flow rate) of the polyester resin composition in accordance with the present invention, which MFR is measured according to JIS K7210 under conditions of a load of 2.16 kg and a temperature of 290° C., is usually from about 40 to about 300 g/10 min, from a viewpoint of melting viscosity and handling facility of the polyester resin composition obtained.

If desired, the components (A) to (C) used in the present invention may be used in combination with usual blending agents used for resins such as heat stabilizers, antioxidants, weather resisting agents, light stabilizers, nucleating agents, lubricants, mold releasing agents, pigments, flame retarding agents, anti-static agents and fillers; reinforcing agents such as glass fiber; and different thermoplastic resins such as polyethylene and polypropylene.

The polyester resin composition in accordance with the present invention can be obtained, for example, according to the following processes (1) to (4).

(1) Process comprising dry-blending all components, and then melt-kneading the obtained blend using an apparatus such as a single or twin screw extruder, Danbury mixer, a roll and a kneader.

(2) Process comprising supplying directly respective components to an extruder of an injection-molding machine, and then melt-kneading the obtained mixture. This process is advantageous from an economical point of view, because an injection-molded article can be obtained from the composition through the injection-molding machine, immediately after said melt-kneading.

(3) Process comprising melt-kneading the component (B) and the component (C), pelletizing the composition obtained, and successively melt-kneading the pellet obtained with the component (A).

(4) Process comprising melt-kneading any component(s) of the components (A) to(C) with a thermoplastic resin, pelletizing the obtained blend, and successively melt-kneading the pellet obtained with the remaining component(s).

Examples of molded articles obtained from the polyester resin composition in accordance with the present invention are electric and electronic parts such as motor covers and electric lampholder covers: car parts such as injection coil covers, engine covers and wheel covers; building materials related to public works and houses such as window sashes; and miscellaneous goods for home use such as hangers, chairs and litter boxes. Among them, preferred are, for example, molded articles having a large size, and molded articles to which properties such as vibration isolating property and impact resistance are required.

### EXAMPLE

The present invention is explained in more detail with reference to Examples, which are not intended to limit the scope of the present invention.

### Examples 1 to 3 and Comparative Examples 1 to 4

Respective components shown In Tables 1 and 2 were dry-blended In the proportion (parts by weight) shown in those tables. Thereafter, the blend obtained was supplied to a unidirectional twin screw extruder having a diameter of 30 mm and an L/D of 42 at a rate of 18 kg/hour to perform melt-kneading at 290° C. under a screw rotating speed of 200 rpm, thereby obtaining a composition having a pellet form.

The pellet obtained was dried in a dehumidification drier at 120° C. for 6 hours, and then subjected to measurement of MFR according to ASTM D256. The pellet obtained was molded at a molding temperature of 290° C. and at a mold temperature of 50° C. using an injection molding machine to obtain a test piece used for a V notched Izod test, which test piece had a thickness of 3.175 mm (⅛ inch), a length of 60.3-63.5 mm and a width of 12.7±0.15 mm. The Izod impact strength was measured according to ASTM D256. The results are as shown in Tables 1 and 2.

TABLE 1

| Example | 1 | 2 | 3 |
|---|---|---|---|
| Component (A) (Note 1) | 100 | 100 | 100 |
| Component (B) (Note 2) | 5.6 | 8.8 | 14.1 |
| Component (C) (Note 3) | 5.6 | 8.8 | 3.5 |
| S value | 3.4 | 4.3 | 3.9 |
| Izod impact strength (KJ/m²) | 8.8 | 52.9 | 40.5 |
| MFR (290° C., 2.16 kg) (g/10 min.) | 78 | 53 | 80 |

TABLE 2

| Comparative Example | 1 | 2 | 3 | 4 |
|---|---|---|---|---|
| Component (A) (Note 1) | 100 | 100 | 100 | 100 |
| Component (B) (Note 2) | 0 | 8.1 | 0 | 10 |
| Component (C) (Note 3) | 0 | 0 | 8.1 | 10 |
| S value | 0 | 2.1 | 2.1 | 4.6 |
| Izod impact strength (KJ/m²) | 1.6 | 3.0 | 2.9 | 61.9 |
| MFR (290° C., 2.16 kg) (g/10 min.) | 91 | 152 | 74 | 38 |

Note 1: A polyester resin obtained by pulverizing and re-pelletizing a recycled PET bottle, a commercial name of RECYCLE PET RESIN manufactured by UTSUMI INCORPORATED.

Note 2; An ethylene-propylene copolymer (propylene unit content=22% by weight), a trademark of ESPRENE V0111, manufactured by Sumitomo Chemical Co. Ltd.

Note 3: An epoxy group-containlng ethylene copolymer 10 (glyoidyl methacrylate unit content=12% by weight, MFR (290° C., 2.16 kg)=3 g/10 min.), a trademark of BONDFAST E, manufactured by Sumitomo Chemical Co., Ltd.

Note 4: In the formula (1), “log” means a natural logarithm. When the value of [B] or [C] is not more than 1, the value of log [B] or log [C] is regarded to be 0 (zero).

1. A polyester resin composition, which comprises:
(A) 100 parts by weight of a polyester resin,
(B) 1 to 50 parts by weight of at least one copolymer selected from the group consisting of an ethylene-α-olefin copolymer and an ethylene-α-olefin-polyene compound copolymer, and
(C) 1 to 16 parts by weight of an epoxy group-containing ethylene copolymer,
provided that an S value represented by the following formula (1) is from 2.5 to 4.5,
S=log [B]+log [C] (1)
wherein [B] and [C] are parts by weight of the component [B] and the component [C] based on 100 parts by weight of the component [A], respectively.

2. The polyester resin composition according to claim 1, wherein the polyester resin (A) comprises a polyethylene terephthalate resin.

3. The polyester resin composition according to claim 1, wherein the polyester resin (A) comprises a recycled polyester resin.

4. The polyester resin composition according to claim 1, wherein at least one copolymer (B) selected from the group consisting of ethylene-α-olefin copolymers and ethylene-α-olefin-polyene compound copolymers comprises a copolymer containing an ethylene unit of from 10 to 99% by mole, provided that the sum of units in the copolymer is assigned to be 100% by mole.

5. The polyester resin composition according to claim 1, wherein the epoxy group-containing ethylene copolymer (C) comprises a copolymer containing an ethylene unit of from 20 to 99% by weight, an epoxy group-containing monomer unit of from 1 to 30% by weight and an ethylenically unsaturated ester unit of from 0 to 50% by weight, provided that the sum of monomer units in the copolymer is assigned to be 100% by weight.

6. The polyester resin composition according to claim 1, wherein the epoxy group-containing ethylene copolymer (C) comprises a copolymer containing an epoxy group-containing monomer unit derived from a compound represented by the following formula (2), 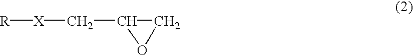
wherein R is an alkenyl group having 2 to 18 carbon atoms, and X is a carbonyloxy group, a methyleneoxy group or a phenyleneoxy group.

7. The polyester resin composition according to claim 1, wherein the polyester resin composition has an MFR (melt flow rate) of from 40 to 300 g/10 min. measured according to JIS K7210 under conditions of a load of 2.16 kg and a temperature of 290° C.

8. An impact resistance improver comprising the polyester resin composition according to claim 1.

9. A flowability improver comprising the polyester resin composition according to claim 1.

10. An injection molded article comprising the resin composition according to claim 1.
